(19) United States
(12) Patent Application Publication
(10) Pub. No.: US 2025/0353386 A1
(43) Pub. Date: Nov. 20, 2025

(54) CHARGING SYSTEM, VOLTAGE CONVERTER UNIT, AND ACCUMULATOR UNIT

(71) Applicant: BRUSA HYPOWER AG, Buchs (CH)

(72) Inventor: Hannes Hobi, Walenstadt (CH)

(21) Appl. No.: 18/872,590

(22) PCT Filed: Jun. 1, 2023
(86) PCT No.: PCT/EP2023/064656

§ 371 Date: Apr. 4, 2025

(30) Foreign Application Priority Data
Jun. 9, 2022 (CH) CH 000701/2022

(51) Int. Cl. B60L 53/10; B60L 3/00; B60L 53/16; B60L 53/20

(52) U.S. Cl. CPC B60L 53/11; B60L 3/0046; B60L 53/16; B60L 53/20; B60L 2210/10; B60L 2210/30

(57) ABSTRACT

A charging system comprising a voltage converter unit and a storage unit, the storage unit designed for the supply of electrical energy via two supply terminals, a storage device of the storage unit comprises two terminals disconnectably connected to the storage device supply terminals via a second and a third disconnection switch, the voltage converter unit designed as a construction unit which is separate from the storage unit and which is connected to the storage unit via three terminals, and in the connected state within the storage unit two of the three terminals are connected to the two terminals of the storage device, and the third of the three terminals is connected to one of the supply terminals, and within the voltage converter unit the third of the three terminals leads via a first disconnection switch. The voltage converter unit comprises a first voltage converter and a second voltage converter.

### CROSS-REFERENCE TO RELATED APPLICATIONS

The present application is the U.S. National Phase of PCT/EP2023/064656, filed on 1 Jun. 2023, which claims priority to Swiss Patent Application No. CH000701/2022, filed on 9 Jun. 2022, the entire contents of which are incorporated herein by reference.

### BACKGROUND

### Field

The invention relates to the field of charging systems for electrical energy storage devices, in particular, mobile electrical energy storage devices, in particular, for electric vehicles.

### Related Art

Known charging devices, in particular, for electric vehicles, are typically connected between a charging station and an electrical energy storage device. They serve for adapting, on demand, a voltage which is present at the charging station to a voltage level of the energy storage device. The following is directed to the voltage at the charging station: either this voltage which is present at an input of the charging device is switched through onto the energy storage device (bypass mode) without a voltage conversion being necessary, or it must be converted by a converter in accordance with the voltage level of the energy storage device. Such charging devices can be subjected to regulations, according to which the energy storage device must be able to be disconnected in a full-pole manner from the charging station by way of mechanical disconnection switches.

In known charging devices, a voltage converter unit is present, said voltage converter unit being connected between the charging station and the energy storage device—typically a rechargeable battery or accumulator. In bypass operation, rapid charging procedures can be carried out, concerning which relatively high currents occur, so that lead cross sections in the voltage converter unit need to be designed accordingly large. Furthermore, for the full-pole disconnection, several disconnection switches need to be present in the voltage converter unit. Moreover, with regard to a modular construction selectively with or without a voltage converter unit, an unnecessary doubling of the elements can occur.

### SUMMARY

It is therefore the object of the invention to provide a charging system, a voltage converter unit and a storage unit of the initially mentioned type, which overcome the aforementioned disadvantages and can be connected to different types of charging stations for a charging procedure.

At least one of these objects is achieved by a charging system, a voltage converter unit and a storage unit, with the features of the respective independent claims.

Herewith, it is possible to disconnect the storage device as well as a voltage converter which is arranged in the voltage converter unit, from the storage device supply terminals in a full-pole manner by way of the three disconnection switches.

Furthermore, it is possible to equip the voltage converter unit with only a single or even with no disconnection switch, since further disconnection switches are present in the storage unit and—because the voltage converter unit is not directly connected to the charging station, but via the storage unit—it is possible for the disconnection of the voltage converter unit from the charging station to be able to be effected in the storage unit via the disconnection switches.

It is further possible to connect the storage unit directly to the first charging station via the two storage device supply terminals, without the leads which are used for this being led through the voltage converter unit. By way of this, in turn high currents as occur given a rapid charging in bypass mode do not need to be led through the voltage converter unit, and leads in the voltage converter unit 3 can be designed accordingly smaller.

It is further possible to design and operate the storage unit completely without the voltage converter unit. Herein, the two storage device supply terminals of the storage unit can be adopted and operated in an unchanged manner, just as supply leads for connection to a first charging station. Thus, starting from the same storage unit, one can realise a configuration with or without the voltage converter unit. On manufacture, this is advantageous due to the storage unit being able to be applied for both configurations in an unchanged manner. Moreover, a storage unit or a vehicle which contains this can also be retrofitted with a voltage converter unit after starting operation. The voltage converter unit can be present as a module or not. Such a module comprises only a single or even no disconnection switch. A total number of disconnection switches is hereby minimised.

The charging system has a first voltage converter and a second voltage converter. This permits a freedom of selection between the two voltage converters depending on the type of charging station which is available for a charging procedure.

In embodiments, the charging system is designed according to at least one of the claims 2, 3, 4, 5, 6, or 7.

In embodiments, the charging system is designed according to claim 8. Herewith, it is possible to manufacture the charging system in the form of separate modules, i.e., voltage converter unit and storage unit, and to bring them together for use. In particular, the charging system which is modularised in such a manner can be operated selectively with or without the voltage converter unit.

In embodiments, the charging system is designed according to claim 9, Herewith, it is possible to create and release the connection between the voltage converter unit and the storage unit in a simple manner.

In embodiments, the charging system is designed according to claim 10. Herewith, it is possible to operate the charging system with a locking system as is common in electrical vehicle technology, for example, Interlock or HV-Interlock, or with pilot contacts.

In embodiments, the charging system is designed according to claim 11 and/or claim 12. Herewith, the charging system is suitable for use in an electric vehicle. Suitable voltages of the charging system can be, for example, 400 volts or 800 volts.

The voltage converter unit is designed according to claim 13. Herewith, the first input terminal can be disconnected from a first voltage converter of the voltage converter unit by way of the first disconnection switch.

The storage unit is designed according to claim 14. Herewith, the storage unit can be selectively operated with or without a voltage converter unit.

### BRIEF DESCRIPTION OF THE DRAWINGS

The subject matter of the invention is hereinafter explained in more detail by way of preferred embodiment examples which are represented in the accompanying drawings. In each case shown schematically are:

FIG. 1 a charging system with a voltage converter unit and a storage unit according to a first embodiment with only a first voltage converter in the voltage converter unit;

FIG. 2 the charging system with a specific first embodiment of the voltage converter unit of FIG. 1;

FIG. 3 a charging system with a voltage converter unit and a storage unit according to a second embodiment with only a first voltage converter in the voltage converter unit;

FIG. 4 the charging system with a specific second embodiment of the voltage converter unit of FIG. 3;

FIG. 5 a charging system according to the invention corresponding to the charging system of FIG. 1, but with two voltage converters in the voltage converter unit,

FIG. 6 the charging system with a specific first embodiment of the voltage converter unit of FIG. 5;

FIG. 7 a charging system according to the invention corresponding to the charging system of FIG. 3, but with two voltage converters in the voltage converter unit; and

FIG. 8 the charging system with a specific second embodiment of the voltage converter unit of FIG. 7.

### DETAILED DESCRIPTION

Basically, in the figures the same or functionally equal parts are provided or are to be provided with the same reference numerals.

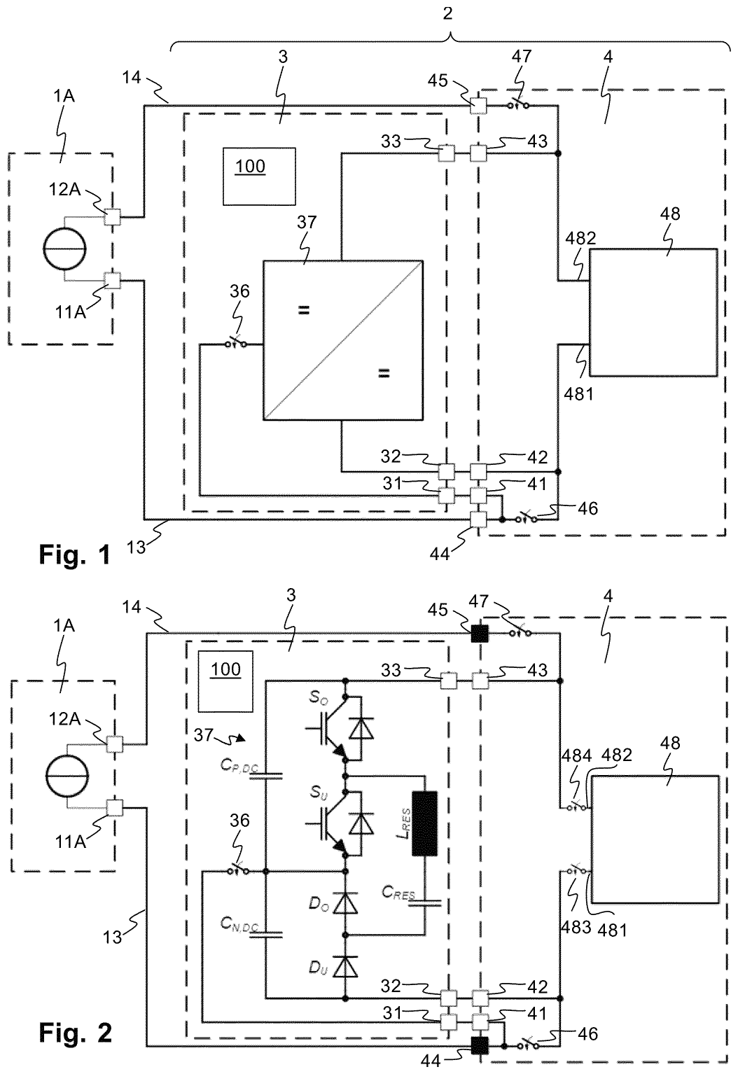

FIG. 1 shows a charging system 2, connected to a first charging station 1A. The charging system 2 comprises a voltage converter unit 3 and a storage unit 4.

The voltage converter unit 3 comprises a first input terminal 31, an output terminal 32, a common terminal 33 and a first voltage converter 37 for converting a first input voltage which is present between the first input terminal 31 and the common terminal 33 into a first output voltage which is present between the output terminal 32 and the common terminal 33.

On operation of the voltage converter 37, its first input voltage is equal to an output voltage of the first charging station 1A, and its first output voltage is equal to a voltage of the storage device 48.

The storage unit 4 comprises:
a first terminal 41 for the connection to the input first terminal 31 of the voltage converter unit 3,
a second terminal 42 for the connection to the output terminal 32 of the voltage converter unit 3 and for feeding a first terminal 481 of the storage device 48,
a third terminal 43 for the connection to the common terminal 33 of the voltage converter unit 3 and for feeding a second terminal 482 of the storage device 48,
a first storage device supply terminal 44 for the connection to a first charging terminal 11A of the first charging station 1A, and
a second storage device supply terminal 45 for the connection to a second charging terminal 12A of the charging station 1A.

The connection of the first and the second storage device supply terminals 44, 45 to a first and a second charging terminals 11A, 12A, respectively, of the first charging station 1 is effected via a first and a second supply leads 13, 14, respectively.

In embodiments, the two supply leads 13, 14 are designed as separate cables and the two storage device supply terminals 44, 45 are formed on separate plugs. Herewith, one succeeds in the individual, separate cables not becoming too heavy, in the case they need to be designed for high charging currents.

In embodiments, the two supply leads 13, 14 are designed in a common cable and the two storage device supply terminals 44, 45 are formed on a common plug.

Within the voltage converter unit 3
the first input terminal 31 of the voltage converter unit 3 is disconnectable from the first voltage converter 37 via a first disconnection switch 36.

Within the storage unit 4
the first storage device supply terminal 44 is connected to the first terminal 41 of the storage unit 4,
the second terminal 42 of the storage unit 4 and the first terminal 481 of the storage device 48 are disconnectably connected to the first storage device supply terminal 44 via a second disconnection switch 46, and
the third terminal 43 of the storage unit 4 and the second terminal 482 of the storage device 48 are disconnectably connected to the second storage device supply terminal 45 via a third disconnection switch 47.

In embodiments, instead of the first storage device supply terminal 44, it is the second storage device supply terminal 45 which is connected to the first terminal 41 of the storage unit 4. Given the same polarity of the storage device 48 and of the first charging station 1A, this corresponds to an operating manner of the voltage converter 37 with a reversed polarity.

The storage unit 4 and, in particular, the storage device 48 can be equipped with a battery management system (not drawn in) and/or a closed-loop control of the charging of a known type. The latter can control, for example, the charging station 1A and/or the voltage converter unit 3 via communication connections (not drawn in).

In embodiments, the storage unit 4 is part of the consumer circuit, in the case of a vehicle also known as a traction circuit, or is connected to a consumer circuit. Furthermore, the storage unit 4 can comprise further disconnection switches 483, 484 for disconnecting the first and second terminal 481, 482 of the storage device 48 from the remaining elements, for example, from the voltage converter unit 3 and the consumer circuit. The presence of such further disconnection switches 483, 484 for the disconnection of the storage unit 4 can be prescribed by standards.

The control of the disconnection switches 36, 46, 47 and of the voltage converter 37 is effected by a control 100 and communication connections (not drawn). By way of example, the control 100 is drawn in the voltage converter unit 3 but can also be arranged in the storage unit 4 or outside both units. Further common elements for ensuring the functioning and safety, for example, for monitoring the storage device supply terminals 44, 45, are not represented.

In the case that the voltage which is provided by first the charging station 1A is not equal to that voltage which is required for charging the storage device 48, the charging system 2 can be switched into a converter mode. In this, the second disconnection switch 46 is opened and the first disconnection switch 36 and third disconnection switch 47 are closed. The voltage converter 37 is clocked.

Herein, the voltage converter converts the voltage of the first charging terminal 11A which is present at the input terminal 31 of the voltage converter unit 3 via the first terminal 41 and the first storage device supply terminal 44 of the storage unit 4 and first supply lead 13, into the voltage which is present at the output terminal 32 of the voltage converter unit 3. This voltage is present at the first terminal 481 of the storage device 48 via the second terminal 42 of the storage unit 4. The mentioned voltages are with respect to the common terminal 33.

The voltage of the second charging terminal 12A is present at the third terminal 43 of the storage unit 4 via the second supply lead 14 and the second storage device supply terminal 45 and thus at the common terminal 33 of the voltage converter unit 3 as well as at the second terminal 482 of the storage device 48.

In the case that the voltage which is provided by the first charging station 1A is equal to the voltage which is required for charging the storage device 48, the charging system 2 can be switched into a bypass mode. In this, the first disconnection switch 36 is opened and the second disconnection switch 46 and third disconnection switch 47 are closed. The first voltage converter 37 is not clocked. The voltage of the charging station 1A is present at the storage device 48.

In the case that the charging system 2 is to be galvanically separated from the charging station 1, all three disconnection switches 36, 46, 47 are opened.

The storage device 48 is typically a rechargeable battery or an accumulator.

As a rule, the voltage converter 37 is a DC-DC converter. For example, it can be a charging pump, a boost converter, a buck-converter or a combination as a boost-buck converter, or have a different topology, for example, a bridge circuit which realises a DC-DC converter. A charging pump can be designed for doubling the voltage or for voltage multiplication.

As a rule, in operation the first voltage converter 37 transfers electrical energy from the first charging station 1A which feeds the first voltage converter 37 via the first input terminal 31 and the common terminal 33, to the storage device 48 which is fed from the first voltage converter 38 via the output terminal 32 and the common terminal 33. In embodiments, a re-feed mode in which energy is transferred in the opposite direction can also be additionally realised. For this, passive valves (diodes) can be replaced by active semiconductor switches in the first voltage converter 37.

FIG. 2 shows a charging system 2 in which the first voltage converter 37 is designed as a charge pump. In the variant of the charge pump which is shown here, an inductance L_{RES} is in series with a storage device capacitance C_{RES}, thus forming a resonant oscillation circuit. The manner of functioning of this first voltage converter 37 is explained in WO 2018/046370 A1, the content of which is herewith adopted in its entirety by reference. FIG. 2 also shows the further disconnection switches 483, 484 for separating the storage device 48. These can also be present in the general representation according to FIG. 1.

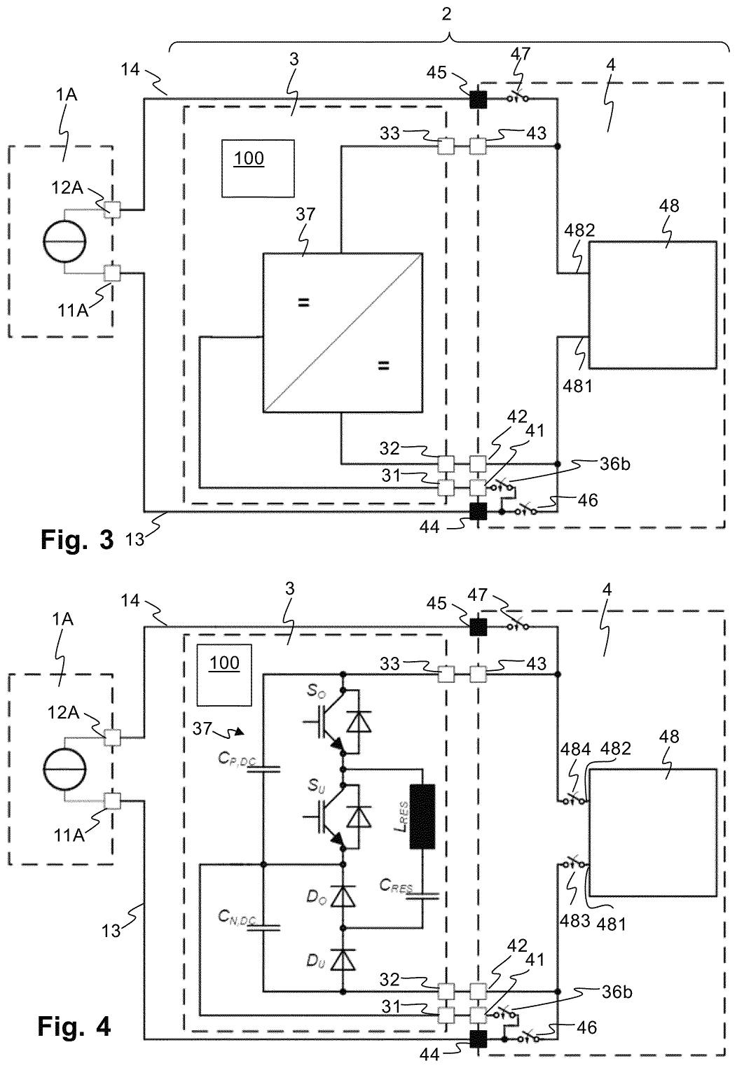

FIGS. 3 and 4, analogously to the FIGS. 1 and 2 each show a charging system 2, in which the first disconnection switch 36 is not arranged in the voltage converter unit 3 but as a first disconnection switch 36b in the storage unit 4. Herein, the first storage device supply terminal 44 or the second storage device supply terminal 45 of the storage unit 4 is disconnectably connected to the first terminal 41 of the storage unit 4 via the first disconnection switch 36b of the storage unit 4. Thus, in the embodiments of FIGS. 3 and 4, no disconnection switch is present in the voltage converter unit 3, in particular, no disconnection switch for disconnecting the third of the three terminals 31 of the voltage converter unit 3.

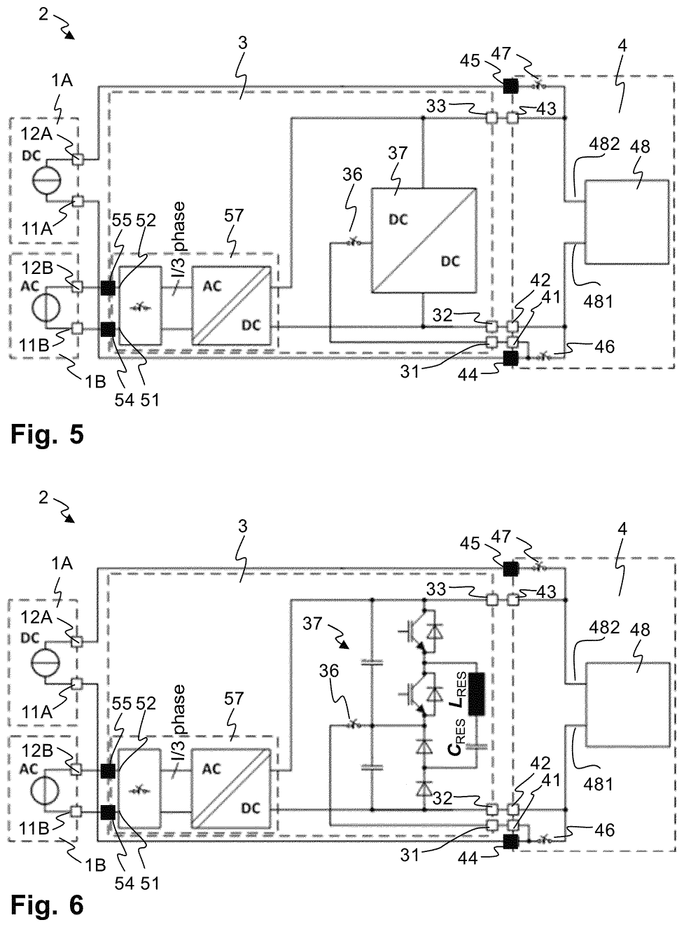

FIG. 5 shows a charging system 2, connectable or connected to a first charging station 1A and/or to a second charging station 1B. The charging system 2 comprises a voltage converter unit 3 and a storage unit 4.

The voltage converter unit 3 comprises a first input terminal 31, an output terminal 32, a common terminal 33, and a first voltage converter 37 for converting a first input voltage which is present between the first input terminal 31 and the common terminal 33 into a first output voltage which is present between the output terminal 32 and the common terminal 33.

Within the voltage converter unit 3
the first input terminal 31 of the voltage converter unit 3 is disconnectable from the first voltage converter 37 via the first disconnection switch 36.

The voltage converter unit 3 additionally comprises a second input terminal 51, a third input terminal 52 and a second voltage converter 57 for converting a second input voltage which is present between the second input terminal 51 and the third input terminal 52 into a second output voltage which is present between the output terminal 32 and the common terminal 33.

The voltage converter unit 3 further comprises:
a first converter supply terminal 54 for the connection to a first charging terminal 11B of a second charging station 1B, and
a second converter supply terminal 55 for the connection onto a second charging terminal 12B of the second charging station 1B.

The second voltage converter 57 as a rule is an AC-DC converter. It can be a mobile electrical converter, in particular, an electrical converter which is integrated into an electric vehicle. Typically, it is used for charging at the electrical mains with two-phase alternating current or three-phase alternating current.

FIG. 6 shows the charging system 2 of FIG. 5 whose voltage converter unit comprises the first voltage converter 37 and the second voltage converter 57. The first voltage converter 37 is designed as a charge pump as in FIG. 2. In the variant of a charge pump which is shown here, an inductance L_{RES} lies in series with a storage device capacitance C_{RES}, thus forming a resonant oscillation circuit. The manner of functioning of this first voltage converter 37 is explained in WO 2018/046370 A1 whose content is herewith adopted in its entirety by reference. The charging system which is shown in FIG. 5 and in FIG. 6 also comprises the further disconnection switches 483, 484 for disconnecting the storage device 48 (not shown in FIGS. 5 and FIG. 6) as is shown in FIG. 2.

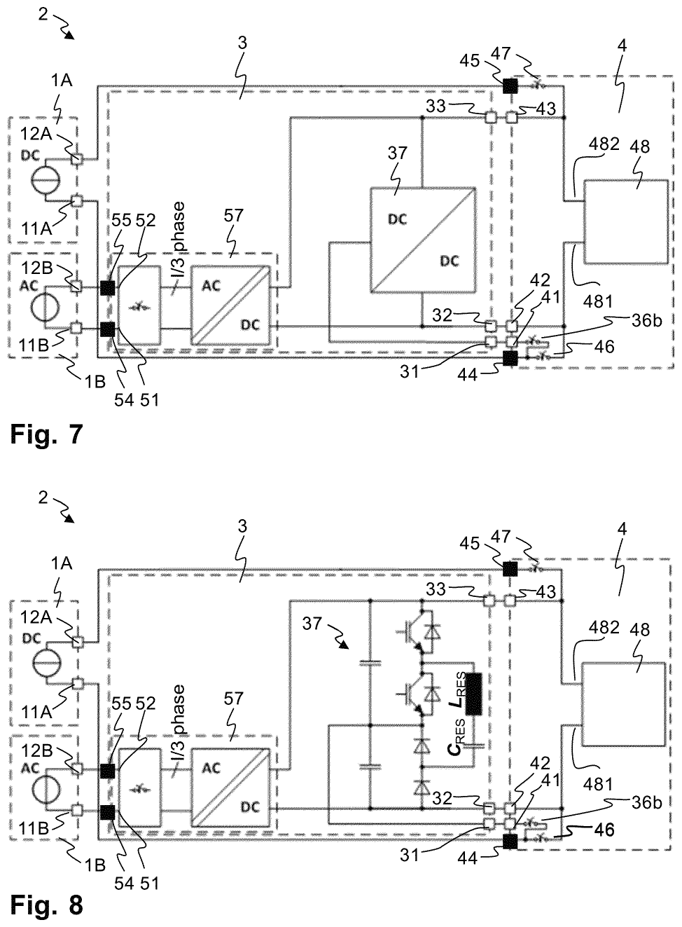

FIGS. 7 and 8, analogously to the FIGS. 5 and 6 each show a charging system 2, in which the first disconnection switch 36 is not arranged in the voltage converter unit 3 but as a first disconnection switch 36b in the storage unit 4. Herein, the first storage device supply terminal 44 or the second storage device supply terminal 45 of the storage unit 4 is disconnectably connected to the first terminal 41 of the storage unit 4 via the first disconnection switch 36b of the storage unit 4. Thus in the embodiments of FIGS. 7 and 8, no disconnection switch is present in the voltage converter unit 3, in particular, no disconnection switch for disconnecting the third of the three terminals 31 of the voltage converter unit 3.

1. A charging system comprising:
storage unit comprising a storage device, wherein the storage unit is configured to supply electrical energy via two storage device supply terminals, the storage device comprising two terminals disconnectably connected to the storage device supply terminals via a second disconnection switch and a third disconnection switch; and
a voltage converter unit configured as a construction unit separate from the storage unit and connected to the storage unit via three terminals of the voltage converter unit, and in a connected state;
within the storage unit
two of the three terminals of the voltage converter unit are connected to the two terminals of the storage device, and
either according to a second embodiment variant within the storage unit
a third of the three terminals of the voltage converter unit is connected to one of the storage device supply terminals via a first disconnection switch,
or according to a first embodiment variant within the storage unit
the third of the three terminals of the voltage converter unit is connected to one of the storage device supply terminals, and
according to the first embodiment variant within the voltage converter unit the third of the three terminals of the voltage converter unit leads via the first disconnection switch, wherein the voltage converter unit comprises a first voltage converter and a second voltage converter.

2. The charging system according to claim 1, wherein the first voltage converter is a DC-DC converter connectable to a DC charging station.

3. The charging system according to claim 1 wherein the second voltage converter is an AC-DC converter connectable to an AC charging station.

4. The charging system according to claim 1,
wherein the voltage converter unit comprises:
a first input terminal,
an output terminal,
a common terminal, and
the first voltage converter to convert a first input voltage present between the first input terminal and the common terminal into a first output voltage present between the output terminal and the common terminal; and
wherein the storage unit comprises:
a first terminal for connection to the first input terminal of the voltage converter unit,
a second terminal for connection to the first output terminal of the voltage converter unit and for feeding a first terminal of the storage device,
a third terminal for connection to the common terminal of the voltage converter unit and for feeding a second terminal of the storage device,
a first storage device supply terminal for connection to a first charging terminal of a first charging station, and
a second storage device supply terminal for connection to a second charging terminal of the first charging station.

5. The charging system according to claim 4, wherein either according to a second embodiment variant:
within the storage unit
the first storage device supply terminal is disconnectably connected to the first terminal of the storage unit via the first disconnection switch,
the second terminal of the storage unit and the first terminal of the storage device are disconnectably connected to the first storage device supply terminal via the second disconnection switch, and
the third terminal of the storage unit and the second terminal of the storage device are disconnectably connected to the second storage device supply terminal via the third disconnection switch;
or according to the first embodiment variant:
within the voltage converter unit
the first input terminal of the voltage converter unit is disconnectable from the voltage converter via the first disconnection switch, and
within the storage unit
the first storage device supply terminal is connected to the first terminal of the storage unit,
the second terminal of the storage unit and the first terminal of the storage device are disconnectably connected to the first storage device supply terminal via the second disconnection switch, and
the third terminal of the storage unit and the second terminal of the storage device are disconnectably connected to the second storage device supply terminal via the third disconnection switch.

6. The charging system according to claim 1,
wherein the voltage converter unit comprises:
a second input terminal,
a third input terminal, and
a second voltage converter for converting a second input voltage present between the second input terminal and the third input terminal into a second output voltage present between the output terminal and the common terminal;
wherein the storage unit comprises:
a first terminal for connection to the input terminal of the voltage converter unit,
a second terminal for connection to the output terminal of the voltage converter unit and for feeding a first terminal of the storage device,
a third terminal for connection to the common terminal of the voltage converter unit and for feeding a second terminal of the storage device,
a first storage device supply terminal for connection to a first charging terminal of a first charging station, and
a second storage device supply terminal for connection to a second charging terminal of the first charging station;
wherein
either according to a second embodiment variant:
within the storage unit
the first storage device supply terminal is disconnectably connected to the first terminal of the storage unit via the first disconnection switch,
the second terminal of the storage unit and the first terminal of the storage device are disconnectably connected to the first storage device supply terminal via the second disconnection switch, and
the third terminal of the storage unit and the second terminal of the storage device are disconnectably connected to the second storage device supply terminal via the third disconnection switch;
or according to the first embodiment variant:
within the voltage converter unit
the first input terminal of the voltage converter unit is disconnectable from the voltage converter via a first disconnection switch, and
within the storage unit
the first storage device supply terminal is connected to the first terminal of the storage unit,
the second terminal of the storage unit and the first terminal of the storage device are disconnectably connected to the first storage device supply terminal via the second disconnection switch, and
the third terminal of the storage unit and the second terminal of the storage device are disconnectably connected to the second storage device supply terminal via the third disconnection switch.

7. The charging system according to claim 1, wherein the voltage converter unit comprises a first converter supply terminal for connection to a first charging terminal of a second charging station, and a second converter supply terminal for connection to a second charging terminal of the second charging station.

8. The charging system according to claim 1, wherein the voltage converter unit is designed to be able to be manufactured, handled, and transported independently of the storage unit.

9. The charging system according to claim 1, wherein the three terminals via which the voltage converter unit is connected to the storage unit are releasable and reconnectable terminals.

10. The charging system according to claim 1, wherein the storage device supply terminals are formed on a single plug or on two separate plugs.

11. The charging system according to claim 1, wherein the storage device supply terminals are designed for a maximal rapid charging current which is more than double a maximal charging current which can be provided by the voltage converter unit.

12. The charging system according to claim 1, wherein the storage device supply terminals are designed for a maximal rapid charging current of above 300 amperes, in particular above 400 amperes, and/or the voltage converter unit is designed for a maximum charging current of above 50 amperes, in particular of above 100 amperes.

13. The charging system according to claim 1, wherein the voltage converter unit comprises:
a first input terminal for connection to a first pole of an input voltage source,
an output terminal for connection to a first pole of a consumer which is to be fed, and
a common terminal for connection to a second pole of the input voltage source and to a second pole of the consumer, wherein the first input terminal leads via the first disconnection switch.

14. The charging system according to claim 1, wherein the storage unit comprises:
two storage device supply terminals and a storage device,
wherein the storage device comprises two terminals which are disconnectably connected to the storage device supply terminals via the second disconnection switch and the third disconnection switch,
wherein the storage unit comprises three terminals for connection to corresponding terminals of voltage converter unit, and
within the storage unit
two of the three terminals are connected to the two terminals of the storage device, and
either according to a second embodiment variant
the third of the three terminals is disconnectably connected to one of the storage device supply terminals via the first disconnection switch,
or according to a first embodiment variant
the third terminal of the three terminals is connected to one of the storage device supply terminals.

15. The charging system according to claim 9, wherein the three terminals are particular plug-in terminals, screw terminals, or clamping terminals.

16. The charging system according to claim 10, wherein the single plug or the two separate plugs each have safety contacts for a pilot circuit or a safety circuit, respectively.

17. The charging system according to claim 1, wherein the charging system is for a mobile storage device.

18. The charging system according to claim 1, wherein the charging system is for a storage device in an electrical vehicle.
